(19) United States
(12) Patent Application Publication
(10) Pub. No.: US 2024/0286958 A1
(43) Pub. Date: Aug. 29, 2024

(54) ACCELERATORS FOR THE REACTION OF STEELMAKING SLAG WITH WATER

(71) Applicant: SIKA TECHNOLOGY AG, Baar (CH)

(72) Inventors: Jérôme SOUDIER, Vaux en Bugey (FR); Olivier LEVESQUE, Crémieu (FR); Javier QUESADA, Madrid (ES); Joris GOUY-PAILLER, Lyon (FR); Ramiro GARCIA, Alcobendas (ES)

(73) Assignee: SIKA TECHNOLOGY AG, Baar (CH)

(21) Appl. No.: 18/289,936

(22) PCT Filed: May 10, 2022
(86) PCT No.: PCT/EP2022/062585

§ 371 Date: Nov. 8, 2023

(30) Foreign Application Priority Data
May 10, 2021 (EP) 21305603.9

(51) Int. Cl. C04B 28/08; C04B 22/08; C04B 22/12; C04B 22/14; C04B 24/00; C04B 24/02; C04B 24/04; C04B 24/06; C04B 24/10; C04B 24/12; C04B 28/12; C04B 103/10

(52) U.S. Cl. CPC C04B 28/082; C04B 22/085; C04B 22/124; C04B 22/14; C04B 22/141; C04B 22/143; C04B 22/147; C04B 24/008; C04B 24/02; C04B 24/04; C04B 24/06; C04B 24/10; C04B 24/122; C04B 24/123; C04B 28/12; C04B 2103/10

(57) ABSTRACT

Accelerators and binders including steelmaking slag and their use in construction materials, wherein the accelerators for the reaction of steelmaking slag with water are being selected from the group consisting of alkanolamines, reducing agents, sugars, sugar acids, carboxylic acids or their salts, amino acids or their salts, sulfamic acid, glyoxal, acetylacetone, pyrocatechol, nitrilotri(methylphosphonic acid), etidronic acid, mineral salts, or mixtures thereof.

### TECHNICAL FIELD

The present invention relates to accelerators for the reaction of steelmaking slag with water. The present invention also relates to binders comprising steelmaking slag and said accelerators and their use in construction materials.

### BACKGROUND OF THE INVENTION

Cement-based building materials, especially concrete or mortars, rely on cementitious materials as binders. Cementitious binders typically are mineral, hydraulic binders the most abundant of which are cements and especially Ordinary Portland Cement (OPC). However, the use of cements and especially of Ordinary Portland Cement has a high environmental footprint. One major reason are the high CO₂ emissions associated with the manufacture of cements. Many efforts have thus been made to at least partially replace cements as binders from building materials.

One possibility is the use of materials with cementitious properties, pozzolanes and/or latent hydraulic materials as cement replacement. An especially appealing material of this kind is slag as it is available as a by-product of various metallurgical process, especially iron and steelmaking, in large quantities.

One specific type of slag is ground granulated blast furnace slag (GGBS). GGBS is obtained by quenching molten iron slag from a blast furnace in water or steam, to produce a glassy, granular product that is then dried and ground into a fine powder.

Another specific type of steelmaking slag is converter slag, also called Basic Oxygen Furnace (BOF) slag. BOF slag is generated during the steelmaking process when raw iron is oxidized in the converter by oxygen to reduce the carbon content of the raw iron.

It is well known in the art that slags, especially GGBS, need to be activated to play their role as hydraulic binders.

For example, WO 2017/198930 (Saint Gobain Weber) teaches a GGBS based binder accelerated by the addition of calcium sulfate and a fine carbonate material or silicate material.

WO 2019/110134 (Ecocem) discloses slag-based binders with an activator for the slag/water reaction selected from alkali metal carbonates, mineral wastes, silica fume, rice husk ash, and/or phosphoric acid. Soluble chlorides, fluorides, and/or sulfates are mentioned as suitable co-activators. Additionally, chelating agents are disclosed which are chosen from phosphonates, phosphates, carboxylates, and amines.

WO 2020/188070 (Tata Steel) discloses a slag mixture with a chelating agent chosen from polycarboxylic acids, most preferably citrates to act as an activating agent and a superplasticizer.

JP 2000169212 (Nippon Kokan) teaches chelating agents selected from triethanolamine, triisopropanolamine, or phenol can act as activating agents for steelmaking slags.

There remains a demand for alternative accelerators for slag to be used as binders in hydraulically setting compositions. Especially, there is a continued need for accelerators that are effective with various types of slag, especially GGBS and BOF slag, and that are safe to use. Typically, very alkaline chemicals and/or accelerators that lead to high dust emissions during handling should be avoided.

### SUMMARY OF THE INVENTION

It is an objective of the present invention to provide accelerators for the reaction of slag, especially GGBS and BOF slag, with water. Specifically, the accelerators should have high activation potential, good availability, low alkalinity, and be safe to handle.

It is also an objective of the present invention to provide a slag-based binder which can be used to replace OPC-based binders.

It is another object of the present invention to provide construction materials based on slag-based binders, especially concrete and mortar compositions.

It has surprisingly been found that chemicals chosen from the group consisting of alkanolamines, reducing agents, sugars, sugar acids, carboxylic acids and their salts, amino acids and their salts, sulfamic acid, glyoxal, acetylacetone, pyrocatechol, nitrilotri(methylphosphonic acid), etidronic acid, mineral salts, or mixtures thereof, are suitable accelerators for the reaction of steelmaking slag with water.

The present invention thus relates to the use of an accelerator for the reaction of steelmaking slag with water, said accelerator being selected from the group consisting of alkanolamines, reducing agents, sugars, sugar acids, carboxylic acids and their salts, amino acids and their salts, sulfamic acid, glyoxal, acetylacetone, pyrocatechol, nitrilotri(methylphosphonic acid), etidronic acid, mineral salts, or mixtures thereof.

It has been found that an accelerator of the present invention leads to an increase in strength, especially in compressive strength as measured according to EN 12190, of the mixture comprising steelmaking slag, water, and the accelerator after a given point of time as compared to the strength, especially the compressive strength, of a mixture of steelmaking slag and water in the same ratio but without the accelerator added and measured after the same time. The time is always measured from the point of addition of water to the steelmaking slag.

It has further been found that accelerators of the present invention can have a positive influence on the rheology of a mixture of steelmaking slag with water. A positive influence in this context means that the viscosity of a mixture comprising steelmaking slag, water, and the accelerator is lower as compared to the viscosity of a mixture of steelmaking slag and water in the same ratio but without the accelerator added.

It has further been found that accelerators of the present invention can have a positive influence on the water demand of a mixture of steelmaking slag with water. A positive influence in this context means that the water demand for achieving a given consistency after mixing of a mixture comprising steelmaking slag, water, and the accelerator is lower as compared to the water demand for achieving the same consistency of a mixture of steelmaking slag and water in the same ratio but without the accelerators added.

It has further been found that accelerators of the present invention can have a positive influence on the fluidity decay over time after wet mixing. A positive influence in this context means that loss of fluidity of a mixture comprising steelmaking slag, water, and accelerator is lower as compared to the loss of fluidity of a mixture of steelmaking slag and water in the same ratio but without the accelerator added.

Further aspects of the present invention are the subject of independent claims. Preferred embodiments of the present invention are the subject of dependent claims.

### DETAILED WAYS OF CARRYING OUT THE INVENTION

In a first aspect the present invention relates to the use of an accelerator for the reaction of steelmaking slag with water, said accelerator being selected from the group consisting of alkanolamines, reducing agents, sugars, sugar acids, carboxylic acids and their salts, amino acids and their salts, sulfamic acid, glyoxal, acetylacetone, pyrocatechol, nitrilotri(methylphosphonic acid), etidronic acid, mineral salts, or mixtures thereof.

Steelmaking slag within the present context is a by-product from the steelmaking process. Within the present context also iron slags, and especially furnace slags, are considered as steelmaking slags. Steelmaking slag is obtained for example in the Thomas process, the Linz-Donawitz process, the Siemens-Martin process or the electric arc furnace when iron is converted to steel. Steelmaking slag is generated when hot raw iron is treated with oxygen to remove carbon and other elements that have a higher affinity to oxygen than iron. Typically, fluxes and/or elements to fix impurities are added during the process, such as limestone or dolomite. Fluxes and fixing aids combine with silicates and oxides to form the liquid slag. Liquid slag is then separated from the crude steel and cooled in pits or ground bays to form crystalline or partly crystalline steelmaking slag. The cooled slag may then be crushed, milled, and sieved to a desired fineness. Preferentially, steelmaking slag of the present invention is a type of slag which has not been additionally treated in the hot state or during the cooling process.

The particle size of a steelmaking slag can be analyzed by sieve analysis as described for example in standard ASTM C136/C136M. The process separates fine particles from more course particles by passing the material through a number of sieves of different mesh sizes. The material to be analysed is vibrated through a series of sequentially decreasing sieves using a single, or combination of horizontal, vertical or rotational motion. As a result, the percentage of particles retained on a sieve of a given size is given.

Another measure for the fineness of a steelmaking slag is the Blaine surface. The Blaine surface can be determined according to NF EN 196-6. According to a preferred embodiment, the steelmaking slag has a Blaine surface of between 1000-8000 cm²/g, preferably 2000-6000 cm²/g, more preferably 3000-5000 cm²/g. This is because the accelerators will accelerate the reaction of steelmaking slag with water to such an extent that also coarser slag can be used. Coarser slag may have the advantage of better availability and lower cost as compared to fine slag. It is, however, also possible to use a steelmaking slag with a higher specific surface.

Steelmaking slag can be any slag resulting from the making of steel. Especially, steelmaking slag is any of granulated blast furnace slag (GBBS), basic oxygen furnace slag (BOF slag), ladle slag or electric arc furnace slag.

A very preferred type of steelmaking slag within the present context is basic oxygen furnace slag (BOF slag). According to embodiments, the steelmaking slag is a basic oxygen furnace slag. Another common name for basic oxygen furnace slag is basic oxygen slag (BOS). The chemical composition of a BOF slag can be determined by XRF as described in ASTM D5381-93. A typical BOF slag has a chemical composition with 27-60 wt.-% of CaO, 8-38 wt.-% of iron oxides, 7-25 wt.-% of SiO₂, 1-15 wt.-% of MgO, 1-8 wt.-% of Al₂O₃, 0.5-8 wt.-% of MnO, 0.05-5 wt.-% of P₂O₅, and some minor components, especially oxides of Ti, Na, K, and Cr, with <1 wt.-%. The chemical composition of a BOF slag may vary depending on steel plant and depending on operation parameter of the basic oxygen furnace. Especially preferred BOF slag has a chemical composition with 35-55 wt.-% of CaO, 10-30 wt.-% of iron oxides, 10-20 wt.-% of SiO₂, 2-10 wt.-% of MgO, 1-5 wt.-% of Al₂O₃, 0.5-5 wt.-% of MnO, 0.5-3 wt.-% of P₂O₅, and some minor components, especially oxides of Ti, Na, K, and Cr, with <1 wt.-%.

A preferred steelmaking slag, especially a basic oxygen furnace slag, has a content of iron oxides expressed as Fe₂O₃ of 8-38 w %, preferably of 10-30 wt.-%, and a content of sulfur expressed as SO₃ of <1 w %, preferably <0.5 w %, especially <0.1 w %, in each case relative to the total dry weight of the steelmaking slag.

It is especially preferred, that the steelmaking slag does not comprise Dicalciumsilicate (C2S, belite) in an amount of more than 66 wt.-% relative to the total dry weight of the slag.

According to embodiments, a second slag different from the steelmaking slag which is a basic oxygen slag, preferably ground granulated blast furnace slag, is used together with said steelmaking slag which is a basic oxygen slag.

The present invention relates to the use of accelerators for the reaction of steelmaking slag with water. When steelmaking slag reacts with water, a hydration reaction occurs and different mineral phases are being formed. Thereby, water and slag are consumed, hardening proceeds and strength is developed. A suitable method to measure the reaction of steelmaking slag with water therefore is the measurement of strength, especially compressive strength. A higher compressive strength corresponds to a higher reaction progress, i.e. more mineral phases being formed. An acceleration of the reaction of steelmaking slag with water can thus be determined by comparing the strength, especially the compressive strength, of different mixtures after a given time of reaction, for example after 2 days, after 7 days, and/or after 28 days. An accelerator for the reaction of steelmaking slag with water will lead to an increase in strength, especially in compressive strength, of the mixture comprising steelmaking slag, water, and the accelerator after a given point of time as compared to the strength, especially the compressive strength, of a mixture of steelmaking slag and water in the same ratio but without the accelerator added and measured after the same time. The time is always measured from the point of addition of water to the steelmaking slag. A suitable procedure for the measurement of compressive strength is described in EN 12190.

The accelerators for the reaction of steelmaking slag with water are selected from the group consisting of alkanolamines, reducing agents, sugars, sugar acids, carboxylic acids and their salts, amino acids and their salts, sulfamic acid, glyoxal, acetylacetone, pyrocatechol, nitrilotri(methylphosphonic acid), etidronic acid, mineral salts, or mixtures thereof.

One type of suitable accelerators are alkanolamines. Alkanolamines are preferably selected from the group consisting of monoethanolamine, diethanolamine, triethanolamine (TEA), diethanolisopropanolamine (DEIPA), ethanoldiisopropanolamine (EDIPA), isopropanolamine, diisopropanolamine, triisopropanolamine (TIPA), N-methyldiisopropanolamine (MDIPA), N-methyldiethanolamine (MDEA), tetrahydroxyethylethylenediamine (THEED), and tetrahydroxyiso-propylethylenediamine (THIPD), as well as mixtures of two or more of these alkanolamines.

Preferred alkanolamines are triethanolamine (TEA), triisopropanolamine (TIPA), diethanolisopropanolamine (DEIPA), and ethanoldiisopropanolamine (EDIPA). Especially preferred alkanolamines are diethanolisopropanolamine (DEIPA), ethanoldiisopropanolamine (EDIPA), and triisopropanolamine (TIPA).

Another type of suitable accelerators are sugars. A “sugar” in the sense of the present invention is a carbohydrate having an aldehyde group. In particularly preferred embodiments, the sugar belongs to the group of monosaccharides or disaccharides. Examples of sugars include, but are not limited to, glyceraldehyde, threose, erythrose, xylose, lyxose, ribose, arabinose, allose, altrose, glucose, mannose, gulose, idose, galactose, tallose, fructose, sorbose, lactose, maltose, sucrose, lactulose, trehalose, cellobiose, chitobiose, isomaltose, palatinose, mannobiose, raffinose, and xylobiose. Sugars can also be used in form of dextrines, vinasse, or molasse. Both, D and L-form of sugars are likewise preferred. Especially preferred sugars are fructose, mannose, maltose, glucose, galactose, dextrines, vinasse, and molasses.

Another type of suitable accelerators are sugar acids or their salts. A “sugar acid” in the context of the present invention is a monosaccharide having a carboxyl group. It may belong to any of the classes of aldonic acids, ursonic acids, uronic acids or aldaric acids. Preferably, it is an aldonic acid. Examples of sugar acids useful in connection with the present invention include, but are not limited to gluconic acid, ascorbic acid, neuraminic acid, glucuronic acid, galacturonic acid, iduronic acid, mucilic acid and saccharic acid. The sugar acid may be in the form of the free acid or as a salt. According to embodiments, salts of sugar acids may be salts with metals of groups Ia, IIa, Ib, IIb, IVb, VIIIb of the periodic table of elements. Preferred salts of sugar acids are salts of alkali metals, alkaline earth metals, iron, cobalt, copper or zinc. Especially preferred are salts with sodium, potassium, and calcium. Both, D- and L-form of sugar acids are likewise preferred. An especially preferred sugar acid is gluconic acid and its salts, especially sodium gluconate.

Another type of suitable accelerators are amino acids or their salts. Amino acids preferably are selected from the group consisting of glycine, lysine, glutamate, glutamic acid, aspartic acid, polyaspartic acid, methionine, nitrilotriacetic acid (NTA), iminodisuccinic acid, methylglycine-N,N-diacetic acid, and N,N-bis(carboxylatomethyl)glutamic acid, ethylenediamine disuccinic acid (EDDS), ethylenediamine tetraacetic acid (EDTA), hexamethylendiamine tatraacetic acid (HEDTA), diethylenetriamine pentaacetic acid (DTPA) or their salts. Especially preferred are salts of alkali metals or alkaline earth metals. In particular, salts are selected from the group consisting of tetratsodium N,N-bis(carboxylatomethyl)glutamate, trisodium methylglycine-N,N-diacetate, tetrasodium iminodisuccinate (IDS), trisodium ethylenediamine disuccinate, tetrasodium ethylenediamine tetraacetate, and tetrasodium hexamethylendiamine tetraacetate.

Another type of suitable accelerators are carboxylic acids or their salts. The term “carboxylic acid” means any organic molecule with a carboxylic acid or carboxylate group, except sugar acids as described above or amino acids as described above. Especially preferred carboxylic acids are formic acid, glycolic acid, citric acid, lactic acid, malic acid, tartaric acid, oxalic acid, malonic acid, succinic acid, glutaric acid, adipic acid, and salicylic acid. The carboxylic acid may be in the form of the free acid or in the form of a salt. According to embodiments, salts of carboxylic acids may be salts with metals of groups Ia, IIa, Ib, IIb, IVb, VIIIb of the periodic table of elements. Preferred salts of sugar acids are salts of alkali metals, alkaline earth metals, iron, cobalt, copper or zinc. Especially preferred are salts with sodium, potassium, and calcium. Preferred salts of carboxylic acids are calcium malonate, calcium succinate, calcium lactate, potassium citrate, and sodium citrate.

Another type of suitable accelerators are reducing agents. Within the present context reducing agents are materials with a reduction potential measured under standard conditions against a standard reference hydrogen half-cell of below 0.77 V. That is, suitable reducing agents have a half-cell potential lower than the couple Fe³⁺/Fe²⁺ Reducing agents are preferably selected from the group consisting of thiosulfates, thiocyanates, and sulfides, preferably from sodium thiosulfate or potassium sulfide.

Reducing agents within the present context do not belong to any of the groups of alkanolamines, sugars, sugar acids, carboxylic acids and their salts, or amino acids and their salts as described above.

Other suitable accelerators are sulfamic acid, glyoxal, acetylacetone, pyrocatechol, nitrilotri(methylphosphonic acid), and etidronic acid.

Another type of suitable accelerators are mineral salts. Within the present context mineral salts are salts selected from the group consisting of alkaline metal or earth alkaline metal nitrates, alkaline metal or earth alkaline metal nitrites, alkaline metal or earth alkaline metal chlorides, aluminum sulfate, aluminum chloride, and calcium sulfate. Especially preferred mineral salts are calcium nitrite, calcium nitrate, calcium chloride, magnesium chloride, aluminum sulfate, aluminum chloride, and calcium sulfate.

According to embodiments, the accelerator is selected from the group consisting of triethanolamine (TEA), triisopropanolamine (TIPA), diethanolisopropanolamine (DEIPA), ethanoldiisopropanolamine (EDIPA), fructose, mannose, maltose, glucose, galactose, dextrines, vinasse, molasses, gluconic acid, ascorbic acid, neuraminic acid, glucuronic acid, galacturonic acid, iduronic acid, mucilic acid, saccharic acid and their sodium, potassium or calcium salts, formic acid, glycolic acid, citric acid, lactic acid, malic acid, tartaric acid, oxalic acid, malonic acid, succinic acid, glutaric acid, adipic acid, salicylic acid and their sodium, potassium or calcium salts, glycine, glutamic acid, aspartic acid, polyaspartic acid, tetrasodium iminodisuccinate (IDS), diethylenetriaminepentaacetic acid (DTMA), nitrilotriacetic acid (NTA), sulfamic acid, glyoxal, acetylacetone, pyrocatechol, nitrilotri(methylphosphonic acid), etidronic acid, calcium nitrite, calcium nitrate, calcium chloride, magnesium chloride, calcium sulfate, aluminum sulfate, aluminum chloride, thiosulfates, especially sodium thiosulfate, thiocyanates, and sulfides, especially potassium sulfide.

According to particularly preferred embodiments, the accelerator is selected from the group consisting of diethanolisopropanolamine (DEIPA), ethanoldiisopropanolamine (EDIPA), lactic acid, calcium lactate, oxalic acid, malonic acid, succinic acid, adipic acid, malic acid, tartaric acid, citric acid, sodium citrate, potassium citrate, gluconic acid, sodium gluconate, glycine, sulfamic acid, glyoxal, acetylacetone, pyrocatechol, tetrasodium iminodisuccinate (IDS), nitrilotriacetic acid (NTA), and calcium sulfate.

According to further preferred embodiments, the accelerator is a mixture of two alkanolamines or of an alkanolamine with at least one further accelerator different from an alkanolamine.

According to especially preferred embodiments, the accelerator is a mixture of diethanolisopropanolamine (DEIPA) and triisopropanolamine (TIPA).

According to further embodiments, the accelerator is a mixture of an alkanolamine selected from the group consisting of triethanolamine (TEA), triisopropanolamine (TIPA), diethanolisopropanolamine (DEIPA), ethanoldiisopropanolamine (EDIPA), and/or methyldiethanolamine (MDEA), especially of TIPA and/or DEIPA, and one further accelerator selected from the group consisting of fructose, mannose, maltose, glucose, galactose, dextrines, vinasse, molasses, gluconic acid, ascorbic acid, neuraminic acid, glucuronic acid, galacturonic acid, iduronic acid, mucilic acid, saccharic acid and their sodium, potassium or calcium salts, formic acid, glycolic acid, citric acid, lactic acid, malic acid, tartaric acid, oxalic acid, malonic acid, succinic acid, glutaric acid, adipic acid, salicylic acid and their sodium, potassium or calcium salts, glycine, glutamic acid, aspartic acid, polyaspartic acid, tetrasodium iminodisuccinate (IDS), diethylenetriaminepentaacetic acid (DTMA), nitrilotriacetic acid (NTA), sulfamic acid, glyoxal, acetylacetone, pyrocatechol, nitrilotri(methylphosphonic acid), etidronic acid, calcium nitrite, calcium nitrate, calcium chloride, magnesium chloride, calcium sulfate, aluminum sulfate, aluminum chloride, thiosulfates, especially sodium thiosulfate, thiocyanates, and sulfides, especially potassium sulfide.

Preferred embodiments of an accelerator of the present invention are mixtures of TIPA and/or DEIPA with at least one of lactic acid, malic acid, tartaric acid, citric acid, sodium citrate, potassium citrate, malonic acid, succinic acid, adipic acid, glycine, sulfamic acid, or their salts, pyrocatechol, sugars, especially fructose, tetrasodium iminodisuccinate (IDS), calcium chloride, and calcium sulfate.

Especially preferred embodiments of an accelerator of the present invention are mixtures of TIPA and/or DEIPA with sugars, preferably fructose.

Further especially preferred embodiment of an accelerator of the present invention are mixtures of TIPA and/or DEIPA with citric acid or its salts, especially with citric acid, sodium citrate, potassium citrate, or calcium citrate.

According to further embodiments, the accelerator is a mixture of an alkanolamine selected from the group consisting of triethanolamine (TEA), triisopropanolamine (TIPA), diethanolisopropanolamine (DEIPA), ethanoldiisopropanolamine (EDIPA), and/or methyldiethanolamine (MDEA), especially of TIPA and/or DEIPA, and two further accelerators, the first further accelerator being selected from sugars, especially fructose, mannose, maltose, glucose, or galactose, and the second further accelerator being selected from the group consisting of mineral salts and reducing agents, preferably from calcium chloride, magnesium chloride, calcium nitrite, calcium nitrate, aluminum sulfate, aluminum chloride, calcium sulfate, sodium thiosulfate and potassium sulfide.

Further especially preferred embodiments of an accelerator of the present invention are mixtures of TIPA and/or DEIPA with a sugar, preferably fructose, and with a carboxylic acid or its salts, preferably citric acid, sodium citrate, potassium citrate, or calcium citrate.

Further especially preferred embodiments of an accelerator of the present invention are mixtures of TIPA and/or DEIPA with a sugar, preferably fructose, and with aluminum sulfate or calcium nitrite.

Further especially preferred embodiments of an accelerator of the present invention are mixtures of TIPA and/or DEIPA with calcium sulfate or calcium nitrate.

According to further embodiments, the accelerator is a mixture of an alkanolamine selected from the group consisting of triethanolamine (TEA), triisopropanolamine (TIPA), diethanolisopropanolamine (DEIPA), ethanoldiisopropanolamine (EDIPA), and/or methyldiethanolamine (MDEA), especially of TIPA and/or DEIPA, and two further accelerators the first further accelerator being selected from sugars, especially fructose, mannose, maltose, glucose, or galactose, and the second further accelerator being selected from the group consisting of sugar acids, carboxylic acids and sulfamic acid, especially gluconic acid, ascorbic acid, neuraminic acid, glucuronic acid, galacturonic acid, iduronic acid, mucilic acid, saccharic acid, salicylic acid and their sodium, potassium or calcium salts, formic acid, glycolic acid, citric acid, lactic acid, malic acid, tartaric acid, oxalic acid, malonic acid, succinic acid, glutaric acid, adipic acid, and their sodium, potassium or calcium salts.

According to further embodiments, the accelerator is a mixture of an alkanolamine selected from the group consisting of triethanolamine (TEA), triisopropanolamine (TIPA), diethanolisopropanolamine (DEIPA), ethanoldiisopropanolamine (EDIPA), and/or methyldiethanolamine (MDEA), especially of TIPA and/or DEIPA, and three further accelerators the first further accelerator being selected from sugars, preferably fructose, mannose, maltose, glucose, or galactose, and the second further accelerator being selected from the group consisting of sugar acids, carboxylic acids and sulfamic acid, preferably gluconic acid, ascorbic acid, neuraminic acid, glucuronic acid, galacturonic acid, iduronic acid, mucilic acid, saccharic acid and their sodium, potassium or calcium salts, formic acid, glycolic acid, citric acid, lactic acid, malic acid, tartaric acid, oxalic acid, malonic acid, succinic acid, glutaric acid, adipic acid, salicylic acid and their sodium, potassium or calcium salts, and the third further accelerator being selected from the group consisting of mineral salts and reducing agents, preferably from calcium chloride, magnesium chloride, calcium nitrite, calcium nitrate, aluminum sulfate, aluminum chloride, calcium sulfate, sodium thiosulfate and potassium sulfide.

According to embodiments, the accelerators of the present invention are used in a pure, undiluted form.

According to different embodiments, the accelerators of the present invention are used as an admixture or as part of an admixture. An admixture comprises or consists of the accelerator or the mixture of accelerators and optionally further ingredients.

Such further ingredients can for example be a solvent, especially water, biocides, or pigments. Accelerators of the present invention may thus also be used in a dispersed or dissolved state, especially dispersed or dissolved in water.

Where the accelerator of the present invention is a mixture of two or more accelerators as described above or where an admixture is used, the accelerator or admixture can be present as a one-component, a two-component, or a multi-component composition. This means that the individual constituents forming the accelerator or admixture of the present invention can be present in an already mixed state within one receptable, forming a one-component composition. The accelerators can also be present in two or more spatially separated receptables forming a two-component or a multi-component composition. This might have benefits regarding the shelf life of the accelerator mixture. This might also facilitate mixing of the accelerators in variable ratios with the steelmaking slag and water. Where the accelerators of the present invention are present in a two-component or in a multi-component composition, they can be pre-mixed or be added individually at the same point of time or be added individually at different points of times.

According to embodiments, the accelerator of the present invention is added in a total amount of between 0.005-25 w %, relative to the total dry weight of the slag. A total amount refers to the sum of w % of all accelerators present.

According to preferred embodiments, alkanolamines are added in a total amount of between 0.005-5 w %, preferably 0.01-3 w %, relative to the total dry weight of the slag.

According to preferred embodiments, sugars are added in a total amount of between 0.005-5 w %, preferably 0.01-3 w %, relative to the total dry weight of the slag.

According to preferred embodiments, carboxylic acids are added in a total amount of between 0.005-5 w %, preferably 0.01-3 w %, relative to the total dry weight of the slag.

According to preferred embodiments, amino acids are added in a total amount of between 0.005-5 w %, preferably 0.01-3 w %, relative to the total dry weight of the slag.

According to preferred embodiments, reducing agents are added in a total amount of between 0.05-10 w %, preferably 0.1-6 w %, relative to the total dry weight of the slag.

According to preferred embodiments, mineral salts are added in a total amount of between 0.005-25 w %, preferably 0.1-10 w % or 2-25 w %, more preferably 0.1-6 w % or 10-25 w %, relative to the total dry weight of the slag. The ranges of 2-25 w %, preferably 10-25 w % especially refer to the use of aluminum sulfate or calcium sulfate as mineral salts.

According to embodiments, any of sulfamic acid, glyoxal, acetylacetone, pyrocatechol, nitrilotri(methylphosphonic acid), and etidronic acid is added in an amount of between 0.05-10 w %, preferably 0.1-6 w %, relative to the total dry weight of the slag.

It has been found that a too high dosage of the accelerator relative to the steelmaking slag reduces the accelerating effect.

Where a mixture of two or more accelerators as described above is used, it is preferred that a weight ratio of (where present) any of
alkanolamine to sugar,
alkanolamine to carboxylic acid,
alkanolamine to amino acid,
sugar to amino acid,
carboxylic acid to amino acid, or
alkanolamine, sugar, carboxylic acid, and amino acid to any of sulfamic acid, glyoxal, acetylacetone, pyrocatechol, nitrilotri(methylphosphonic acid), and etidronic acid
is in the range of 1:50 to 50:1, preferably 1:20 to 20:1

Where a mixture of two or more accelerators as described above is used, it is preferred that a weight ratio of (where present) any selection or combination of alkanolamine, sugar, carboxylic acid, amino acid, sulfamic acid, glyoxal, acetylacetone, pyrocatechol, nitrilotri(methylphosphonic acid), and etidronic to any selection or combination of mineral salt and reducing agent is within the range of 1:5000 to 1:1000, preferably 1:2500 to 1:1000.

In another aspect the present invention also relates to a slag based binder, preferably for use as a binder in concrete or mortars, said binder comprising or consisting of
a) at least one steelmaking slag, preferably basic oxygen furnace slag,
b) at least one accelerator for the reaction of the steelmaking slag with water, said accelerator being selected from the group consisting of alkanolamines, reducing agents, sugars, sugar acids, carboxylic acids or their salts, amino acids or their salts, sulfamic acid, glyoxal, acetylacetone, pyrocatechol, sulfamic acid, glyoxal, acetylacetone, pyrocatechol, nitrilotri(methylphosphonic acid), etidronic acid, mineral salts, or mixtures thereof,
c) optionally a second slag which is different from a), preferably granulated blast furnace slag,
c) optionally at least one co-binder
d) optionally further additives different from b).

It is to be understood that any embodiments, especially related to the steelmaking slag and the at least one accelerator, described as preferred above also apply to the slag based binder of the present invention.

According to some embodiments, a slag based binder of the present invention comprises an accelerator selected from the group consisting of diethanolisopropanolamine (DEIPA), ethanoldiisopropanolamine (EDIPA), lactic acid, calcium lactate, oxalic acid, malonic acid, succinic acid, adipic acid, malic acid, tartaric acid, citric acid, gluconic acid, sodium gluconate, glycine, sulfamic acid, glyoxal, acetylacetone, pyrocatechol, tetrasodium iminodisuccinate (IDS), nitrilotriacetic acid (NTA), and calcium sulfate.

According to further embodiments, a slag based binder of the present invention comprises an accelerator which is a mixture of diethanolisopropanolamine (DEIPA) and triisopropanolamine (TIPA).

According to further embodiments, a slag based binder of the present invention comprises an accelerator which is a mixture of an alkanolamine selected from the group consisting of triethanolamine (TEA), triisopropanolamine (TIPA), diethanolisopropanolamine (DEIPA), ethanoldiisopropanolamine (EDIPA), and/or methyldiethanolamine (MDEA), especially of TIPA and/or DEIPA, and one further accelerator selected from the group consisting of lactic acid, malic acid, tartaric acid, citric acid, malonic acid, succinic acid, adipic acid, glycine, sulfamic acid, or their salts, pyrocatechol, sugars, especially fructose, tetrasodium iminodisuccinate (IDS), calcium chloride, and calcium sulfate.

According to further embodiments, a slag based binder of the present invention comprises an accelerator which is a mixture of an alkanolamine selected from the group consisting of triethanolamine (TEA), triisopropanolamine (TIPA), diethanolisopropanolamine (DEIPA), ethanoldiisopropanolamine (EDIPA), and/or methyldiethanolamine (MDEA), especially of TIPA and/or DEIPA, and two further accelerators, the first further accelerator being selected from sugars, especially fructose, mannose, maltose, glucose, or galactose, and the second further accelerator being selected from the group consisting of mineral salts, preferably of calcium chloride, calcium nitrite, calcium nitrate, aluminum sulfate, aluminum chloride, and calcium sulfate.

A co-binder within the present context is an inorganic binder selected from the group consisting of cement, gypsum, lime, calcined magnesia, caustic magnesia, alumina, latent hydraulic binders, and/or pozzolanes. Cements can in particular be Portland cements of type CEM I, CEM II, and CEM IV with the exception of CEM II/A-S and CEM II/B-S as described in standard EN 197-1, calcium aluminate cements as described in standard EN 14647, and/or calcium sulfoaluminate cements. The term “gypsum” is meant to encompass CaSO₄ in various forms, in particular CaSO₄ anhydrite, CaSO₄ α- and β-hemihydrate, and CaSO₄ dihydrate. The term “lime” is meant to encompass natural hydraulic lime, formulated lime, hydraulic lime, and air lime as described in the standard EN 459-1:2015. The term “alumina” stands for aluminum oxides, aluminum hydroxides, and/or aluminum oxy-hydroxides such as gibbsite and boehmite, calcined or flash calcined alumina, alumina resulting from the Bayer process, hydratable alumina such as amorphous mesophase alumina and rho phase alumina. Pozzolanes and latent hydraulic materials preferably are selected from the group consisting of clay, which can be crude clay or calcined clay, especially metakaolin, or kiln dust, microsilica, fly ash, pyrogenic silica, precipitated silica, silica fume, sodocalcic glass, borocalcic glass, zeolite, rice husk ash, burnt oil shale, and natural pozzolane such as pumice and trass. Pozzolanes and latent hydraulic binders do not encompass steelmaking slags within the present context. Preferably, the co-binder is selected from the group consisting of Portland cement, calcium aluminate cement, calcium sulfoaluminate cement, gypsum, hydraulic lime, air lime, calcined magnesia, caustic magnesia, calcined alumina, hydratable alumina, aluminum hydroxide, pozzolanes, especially clays, pyrogenic silica, silica fume, fly ash, and latent hydraulic binder, where pozzolane and latent hydraulic binder does not encompass steelmaking slag. Especially preferred, the co-binder is selected from the group consisting of Portland cement, calcium aluminate cement, calcium sulfoaluminate cement, gypsum, calcium sulfate, lime, calcined clays, ground calcium carbonate, pozzolanes, silica fume, fly ash, caustic magnesia, and latent hydraulic binder, where pozzolane and latent hydraulic binder do not encompass steelmaking slag.

Especially preferred combinations of co-binders are combinations of calcined clays or of crude clays with calcium sulfate, combinations of Portland cement or calcium sulfoaluminate cement or calcium aluminate cement with calcium sulfate, combinations of calcium sulfoaluminate cement or calcium aluminate cement with Portland cement, combinations of calcium sulfoaluminate cement or calcium aluminate cement with Portland cement and calcium sulfate, combinations of calcium sulfoaluminate cement or calcium aluminate cement with lime, combinations of Portland cement with calcium sulfate and calcined clays, and combinations of calcined clays or of crude clays with Portland cement.

According to embodiments, where a co-binder is present, a weight ratio of steelmaking slag, especially basic oxygen furnace slag, to co-binder in a slag based binder as described above is between 1:19-19:1, preferably 1:9-15:1, more preferably 1:6-12:1, still more preferably 1:5-9:1, highly preferred 1:3-6:1, especially 1:1-5:1.

Optionally, a slag-based binder of the present invention additionally comprises further additives different from the accelerator for the reaction of steelmaking slag with water. According to embodiments, such further additives are selected from the group consisting of plasticizers, superplasticizers, shrinkage reducers, air entrainers, de-aerating agents, stabilizers, viscosity modifiers, thickeners, water reducers, retarders, water resisting agents, fibers, blowing agents, defoamers, redispersible polymer powders, dedusting agents, chromate reducers, pigments, biocides, corrosion inhibitors, and steel passivating agents.

According to some embodiments, a slag based binder of the present invention comprises or consists of (in each case relative to the total dry weight of the slag based binder)
a) 75-99.995 w %, preferably 95-99.99 w %, of at least one steelmaking slag, preferably basic oxygen furnace slag,
b) 0.005-25 w %, preferably 0.01-5 w %, of at least one accelerator for the reaction of the steelmaking slag with water,
where said accelerator is selected from the group consisting of alkanolamines, reducing agents, sugars, sugar acids, carboxylic acids or their salts, amino acids or their salts, sulfamic acid, glyoxal, acetylacetone, pyrocatechol, nitrilotri(methylphosphonic acid), etidronic acid, mineral salts, or mixtures thereof.

According to further embodiments, a slag based binder of the present invention comprises or consists of (in each case relative to the total dry weight of the slag based binder)
a) 74.9-99.895 w %, preferably 74.99-99.89 w %, of at least one steelmaking slag, preferably basic oxygen furnace slag,
b) 0.005-25 w %, preferably 0.01-5 w %, of at least one accelerator for the reaction of the steelmaking slag with water,
c) 0.1-25 w % of a co-binder selected from clay or lime,
where said accelerator is selected from the group consisting of alkanolamines, reducing agents, sugars, sugar acids, carboxylic acids or their salts, amino acids or their salts, sulfamic acid, glyoxal, acetylacetone, pyrocatechol, nitrilotri(methylphosphonic acid), etidronic acid, mineral salts, or mixtures thereof.

According to further embodiments, a slag based binder of the present invention comprises or consists of (in each case relative to the total dry weight of the slag based binder)
a) 74.9-99.895 w %, preferably 74.99-99.89 w %, of at least one steelmaking slag, preferably basic oxygen furnace slag,
b) 0.005-25 w %, preferably 0.01-5 w %, of at least one accelerator for the reaction of the steelmaking slag with water,
c) 0.1-25 w % of a co-binder selected from calcium sulfoaluminate cement,
where said accelerator is selected from the group consisting of alkanolamines, reducing agents, sugars, sugar acids, carboxylic acids or their salts, amino acids or their salts, sulfamic acid, glyoxal, acetylacetone, pyrocatechol, nitrilotri(methylphosphonic acid), etidronic acid, mineral salts, or mixtures thereof.

According to further embodiments, a slag based binder of the present invention comprises or consists of (in each case relative to the total dry weight of the slag based binder)
a) 49.995-99.895 w %, preferably 49.99-99.89 w %, of at least one steelmaking slag, preferably basic oxygen furnace slag,
b) 0.005-25 w %, preferably 0.01-5 w %, of at least one accelerator for the reaction of the steelmaking slag with water,
c) 0.1-50 w % of a co-binder selected from a combination of clay with calcium sulfate or a combination of calcium aluminate cement with calcium sulfate or a combination of calcium sulfoaluminate cement with calcium sulfate,
where said accelerator is selected from the group consisting of alkanolamines, reducing agents, sugars, sugar acids, carboxylic acids or their salts, amino acids or their salts, sulfamic acid, glyoxal, acetylacetone, pyrocatechol, nitrilotri(methylphosphonic acid), etidronic acid, mineral salts, or mixtures thereof.

The preferred accelerators in any of these embodiments are the same as described above.

In yet another aspect, the present invention also relates to a construction material, especially a mortar or a concrete comprising the slag-based binder as described above.

Thus, in particular, the present invention also relates to a construction material, preferably a concrete or mortar composition comprising or consisting of (in each case relative to the total dry weight of the construction material)
a) 5-95 w %, preferably 5-60 w % of a slag based binder, said slag based binder comprising or consisting of
a1) at least one steelmaking slag, preferably basic oxygen furnace slag,
a2) at least one accelerator for the reaction of the steelmaking slag with water, said accelerator being selected from the group consisting of alkanolamines, reducing agents, sugars, sugar acids, carboxylic acids or their salts, amino acids or their salts, sulfamic acid, glyoxal, acetylacetone, pyrocatechol, nitrilotri(methylphosphonic acid), etidronic acid, mineral salts, or mixtures thereof, preferably selected from the accelerators described as preferred above,
a3) optionally a second slag which is different from a1), preferably granulated blast furnace slag,
b) 5-95 w %, preferably 30-90 w % of at least one aggregate,
c) 0-90 w %, preferably 5-30 w % of at least one co-binder, said co-binder being different from the slag based binder a) and said co-binder being selected from the group consisting of cement, gypsum, lime, calcined magnesia, caustic magnesia, alumina, latent hydraulic binders, and/or pozzolanes,
d) 0-10 w % of further additives, and
e) optionally water in an amount to realize a mass ratio of water:dry constituents between 0.1-0.6, preferably 0.2-0.5, especially 0.2-0.35.

The slag-based binder, the co-binder, and the further additives preferably are as described above. It can be preferred to combine two or more further additives in a construction material of the present invention. Thus, the construction material of the present invention comprises a steelmaking slag as described above and an accelerator selected from the group consisting of alkanolamines, reducing agents, sugars, sugar acids, carboxylic acids or their salts, amino acids or their salts, sulfamic acid, glyoxal, acetylacetone, pyrocatechol, sulfamic acid, glyoxal, acetylacetone, pyrocatechol, nitrilotri(methylphosphonic acid), and etidronic acid, alkaline metal or earth alkaline metal nitrates or nitrites or chlorides, aluminum sulfate, aluminum chloride, calcium sulfate, or mixtures thereof, as described above.

According to preferred embodiments, the construction material comprises at least one co-binder in 5-90 w %, preferably 5-30 w %, the co-binder being selected from Portland cement, calcium aluminate cement, calcium sulfoaluminate cement, gypsum, calcium sulfate, lime, calcined clays, ground calcium carbonate, pozzolanes, silica fume, fly ash, caustic magnesia, and latent hydraulic binder, where pozzolane and latent hydraulic binder do not encompass slag.

Aggregates can be any material that is non-reactive in the hydration reaction of binders. Aggregates can be any aggregate typically used for construction materials. Typical aggregates are for example rock, crushed stone, gravel, sand, especially quartz sand, river sand and/or manufactured sand, recycled concrete, glass, expanded glass, hollow glass beads, glass ceramics, volcanic rock, pumice, perlite, vermiculite, quarry wastes, raw, fired or fused earth or burnt clay, porcelain, electrofused or sintered abrasives, firing support, silica xerogels. Aggregates may also be fine aggregates or fillers such as ground limestone, ground dolomite, and/or ground aluminum oxide. Aggregates useful for the present invention can have any shape and size typically encountered for such aggregates. An especially preferred aggregate is sand. Sand is a naturally occurring granular material composed of finely divided rock or mineral particles. It is available in various forms and sizes. Examples of suitable sands are quartz sand, limestone sand, river sand or crushed aggregates. Suitable sands are for example described in standards ASTM C778 or EN 196-1.

According to embodiments, aggregates can also be one or more of the following (i)-(v):
(i) biosourced materials, preferably of plant origin, more preferably biosourced materials of plant origin essentially composed of cellulose and/or lignin, especially biosourced materials originating from hemp, flax, cereal straw, oats, rice, rape, maize, sorghum, flax, miscanthus, rice husk, sugar cane, sunflower, kenaf, coconut, olive stones, bamboo, wood, or mixtures thereof. According to embodiments, biosourced materials of plant origin have a defined form which is preferably selected from fibres, fibrils, dust, meal, powders, shavings, pith, in particular pith of sunflower, maize, rape seed, and mixtures thereof.
(ii) synthetic non-mineral materials, preferably selected from the group comprising or consisting of thermoplastics, thermosetting plastics or resins, elastomers, rubbers, textiles fibers, plastic materials reinforced with glass or carbon fibers. Synthetic non-mineral materials can be filled or unfilled.
(iii) aggregates of inorganic nature from the deconstruction of civil engineering or building structures, preferably selected from the group comprising or consisting of waste concrete, mortar, bricks, natural stone, asphalt, tiles, tiling, aerated concrete, clinker, scrap metal.
(iv) aggregates of organic nature from the recycling of industrial products, in particular composite materials which are difficult to recycle, especially recycled insulating materials. Especially preferred examples are polystyrenes, polyurethanes, epoxy resins, phenolic resins, wood insulating materials, and mixtures thereof.
(v) non-hazardous granular materials usually destined for landfill such as used foundry sands, catalyst supports, Bayer process treatment supports, clinker aggregates, fillers from the treatment of excavation sludge, sewage sludge, slurry, paper waste, paper incineration ashes, household waste incineration ashes.

Most preferably, aggregates are in particulate form.

Throughout this invention, where a mass ratio of water:dry constituents is calculated, the total dry weight of the slag-based binder and of the optionally present co-binder shall be taken into account. No corrections shall be made to compensate for any degree of hydraulicity. The term dry constituents in this context relates to all powdery components of a composition, especially slag based binder, aggregate, and co-binder.

The weight ratio of water to binder can be adjusted to control the rheology and/or strength of the wet construction material. A higher amount of water will lead to a more flowable wet composition and a lower amount of water to a pasty wet composition. The rheology may be adjusted by the amount of water in a way to yield a wet composition with a rheology ranging from self-levelling to very thick. Typically, a lower amount of water will also lead to an increased strength.

According to embodiments, where a co-binder is present, a weight ratio of slag based binder to co-binder in a construction material as described above is between 1:19-19:1, preferably 1:9-15:1, more preferably 1:6-12:1, still more preferably 1:5-9:1, highly preferred 1:3-6:1, especially 1:1-5:1.

According to embodiments, a hydraulically setting composition of the present invention comprises from 15-85 wt.-%, preferably 35-80 wt.-%, especially 50-75 wt.-%, each based on the total dry weight of the composition, of sand.

Further additives can be any additives common to the mortar and concrete industry. Especially the further additives can be selected from plasticizers, superplasticizers, shrinkage reducers, air entrainers, de-aerating agents, stabilizers, viscosity modifiers, thickeners, water reducers, retarders, water resisting agents, fibers, blowing agents, defoamers, redispersible polymer powders, dedusting agents, chromate reducers, pigments, biocides, corrosion inhibitors, and steel passivating agents.

According to embodiments, a construction material, especially a concrete or mortar, of the present invention comprises at least one superplasticizer selected from the group consisting of lignosulfonates, sulfonated vinylcopolymers, polynaphthalene sulfonates, sulfonated melamine formaldehyde condensates, polyethylene oxide phosphonates, polycarboxylate ethers (PCE), or mixtures thereof. Preferably, a construction material, especially a concrete or mortar, of the present invention comprises a PCE. Such PCE are particularly well suited to allow good processability of the hydraulically setting composition even at low water content.

According to embodiments, a construction material, especially a concrete or mortar, of the present invention comprises at least one thickener selected from the group consisting of starch, pectin, amylopectin, modified starch, cellulose, modified cellulose, such as carboxymethylcellulose, hydroxymethylcellulose, hydroxyethylcellulose, methylhydroxyethylcellulose, casein, xanthan gum, diutan gum, welan gum, galactomannanes, such as guar gum, tara gum, fenugreek gum, locust bean gum or cassia gum, alginates, tragacanth gum, dextran, polydextrose, layered silicates such as sepiolite, bentonite or vermiculite, and mixtures thereof.

According to embodiments, a construction material, especially a concrete or mortar, of the present invention comprises at least one redispersible polymer powder. The term redispersible polymer powder refers to a powder which contains a polymer and after introduction into water forms a stable dispersion. A redispersible polymer powder encompasses not only the polymer but typically also mixtures thereof with e.g. protective colloids, emulsifiers, and support materials. Redispersible polymer powders can be manufactured for example by spray drying of polymer dispersions as for example described in patent application EP1042391. Suitable redispersible powders are for example available from Wacker Chemie AG under the trade name Vinnapas. The use of redispersible powders of synthetic organic polymers is preferred for the context of the present invention. A synthetic organic polymer within the context of the present invention can be produced by radical polymerization of monomers selected form the group consisting of ethylene, propylene, butylene, isoprene, butadiene, styrene, acrylonitrile, acrylic acid, methacrylic acid, esters of acrylic acid, esters of methacrylic acid, vinylesters, vinylchloride. It is preferred that synthetic polymers are copolymers synthesized from two or more, preferably two, different monomers. The sequence of the copolymer can be alternating, blocked or random. Preferred synthetic organic polymers are copolymers of vinylacetate and ethylene, vinylacetate and ethylene and methylmethacrylate, vinylacetate and ethylene and vinylester, vinylacetate and ethylene and acrylic acid ester, vinylchloride and ethylene and vinyllaureate, vinylacetate and vinylveratate, acrylic ester and styrene, acrylic ester and styrene and butadiene, acrylic ester and acrylonitrile, styrene and butadiene, acrylic acid and styrene, methacrylic acid and styrene, styrene and acrylic acid ester, styrene and methacrylic acid ester. The glass transition temperature (Tg) of said synthetic organic polymers can vary in a wide range. Tg of suitable synthetic organic polymers can be for example between −50° C. and +60° C., preferably between −45° C. and +35° C., more preferred between −25° C. and +15° C.

A construction material of the present invention, especially a concrete or mortar, may also contain liquid additives. Such liquid additives may be mixed with dry constituents of the construction material and lead to construction materials with a powdery or pasty consistency. The liquid additives can, for example, be aqueous solutions or dispersions of, for example, plasticizers or superplasticizers. Where water or aqueous additives are added to a construction material which is intended to be a dry mix, the amount of water should be limited to not more than 0.5 w % relative to the total dry weight of the construction material.

According to preferred embodiments a construction material, especially a concrete or mortar formulation comprises (in each case relative to the total dry weight of the construction material)
a) 5-95 w %, preferably 5-60 w % of a slag based binder, said slag based binder comprising:
   a1) at least one steelmaking slag, preferably basic oxygen furnace slag,
   a2) at least one accelerator for the reaction of the steelmaking slag with water, said accelerator being selected from the group consisting of alkanolamines, reducing agents, sugars, sugar acids, carboxylic acids or their salts, amino acids or their salts, sulfamic acid, glyoxal, acetylacetone, pyrocatechol, sulfamic acid, glyoxal, acetylacetone, pyrocatechol, nitrilotri(methylphosphonic acid), and etidronic acid, mineral salts, or mixtures thereof,
   a3) optionally a second slag which is different from a1), preferably granulated blast furnace slag,
b) 5-95 w %, preferably 30-90 w % of at least one aggregate,
c) 0-90 w %, preferably 5-30 w % of at least one co-binder, the co-binder being selected from Portland cement, calcium aluminate cement, calcium sulfoaluminate cement, gypsum, hydraulic lime, air lime, calcined magnesia, caustic magnesia, calcined alumina, hydratable alumina, aluminum hydroxide, pozzolanes, especially clays, pyrogenic silica, silica fume, fly ash, and latent hydraulic binder, where pozzolane and latent hydraulic binder does not encompass steelmaking slag,
d) 0-10 w % of further additives, and
e) optionally water in an amount to realize a mass ratio of water:dry constituents between 0.1-0.6, preferably 0.2-0.5, especially 0.2-0.35.

All features described as preferred above shall also apply in this case.

According to other embodiments, the present invention also relates to a construction material, preferably a concrete or mortar composition, comprising or consisting of (in each case relative to the total dry weight of the construction material)
a) 5-95 w %, preferably 5-60 w % of a slag based binder, said slag based binder comprising or consisting of
a1) at least one steelmaking slag, preferably basic oxygen furnace slag,
a2) at least one accelerator for the reaction of the steelmaking slag with water as described above,
a3) optionally a second slag which is different from a1), preferably granulated blast furnace slag,
b) 5-95 w %, preferably 30-90 w % of at least one aggregate,
c) optionally 20-80 w %, preferably 40-80 w % of at least one co-binder selected from the group consisting of Portland Cements, calcium aluminate cements, calcium sulfoaluminate cements, gypsum or mixtures thereof,
d) 0-10 w % of further additives, and
e) optionally water in an amount to realize a mass ratio of water:dry constituents between 0.1-0.6, preferably 0.2-0.5, especially 0.2-0.35.

A construction material of the present invention can be made by mixing the constituents, especially the slag based binder, the aggregate, and optionally present co-binder, further additives, and water by conventional means. Suitable mixers are for example horizontal single shaft mixers, twin shaft paddle mixers, vertical shaft mixers, ribbon blenders, orbiting mixers, change-can mixers, tumbling vessels, vertical agitated chambers or air agitated operations. Mixing can be continuous or batch-wise.

According to a preferred embodiment, the construction material of the present invention is a one-component mixture. That means that all the individual constituents are intermixed. One-component compositions are in particular easy to handle and exclude the risk of a mix up or wrong dosing of individual constituents by users.

However, it is in principle possible to provide the construction material of the present invention as a two-component or even a multi-component composition. Two- or multi-component compositions allow e.g. for adjusting the construction material with regard to specific applications.

Typically, a dry construction material of the present invention is mixed with water only very shortly before its application. This is because upon contact with water, a construction material of the present invention will start to harden. It is thus especially preferred to first make a dry construction material, especially a dry mortar or dry concrete, as described above and then mix this dry construction material with water at or near the place of application.

Methods and devices for mixing of the dry construction material with water are not particular limited and are known to the person skilled in the art. Mixing can be continuous, semi-continuous or batch-wise. Continuous mixing offers the advantage of a high material throughput.

The construction material, especially the concrete or mortar, of the present invention may thus be a dry construction material or a wet construction material.

According to embodiments a dry construction material is especially a dry mortar, a readymix mortar, or dry concrete. According to still further embodiments, a dry composition as described above is prepared on a job site, for example by intermixing at least one of the constituents with other constituents of the dry composition and/or by intermixing two or more components of a multicomponent material.

A construction material of the present invention may be a cementitious tile adhesive, a grouting material, a self-levelling underlayment, a self-levelling overlayment, a render, a repair mortar, a masonry thin join mortar or concrete, a screed, a wall leveller for interior or exterior use, a non-shrink grout, a thin joint mortar, a waterproofing mortar, or an anchoring mortar. A cementitious tile adhesive is especially according to standard EN 12004-1. A grouting material is especially according to standard EN 13888. A self-levelling underlayment or a self-levelling overlayment is especially according to standard EN 13813. A render is especially according to standard EN 998-1. A repair mortar is especially according to standard EN 1504-3. A masonry mortar or concrete is especially according to standards EN 998-2 and EN 206-1. A screed is especially according to standard EN 13813. A non-shrink grout is especially according to standard EN 1504-6. A thin joint mortar is especially according to standard EN 998-2. A waterproofing mortar is especially according to standard EN 1504-2. An anchoring mortar is especially according to standard EN 1504-6.

Upon mixing with water, a construction material, especially a concrete or mortar, of the present invention will start to set and harden. The setting and hardening of a construction material proceeds with time and physical properties, e.g. compressive strength is developed thereby.

In a last aspect the present invention relates to a hardened body obtained by curing a concrete or mortar composition as described above and which slag based binder or construction material has been mixed with water in an amount to realize a mass ratio of water:dry constituents between 0.1-0.6, preferably 0.2-0.5, especially 0.2-0.35.

Conditions for curing are not particularly limited and are known to the person skilled in the art. Especially, curing can be done at temperatures between 5° C. and 200° C. and at pressures between 1 atm and 12 atm. Curing is possible under normal atmosphere, or in a water saturated atmosphere or under any other atmosphere. It is preferred that curing is done at 1 atm pressure and between 5° C. and 35° C.

The following examples will provide the skilled person with further embodiments of the present invention. They are not intended to limit the invention in any way.

### EXAMPLES

Triisopropanolamine (TIPA), diethanolisopropanolamine (DEIPA), ethanoldiisopropanolamine (EDIPA), citric acid (including potassium and sodium salts), tartaric acid (L-form), malonic acid, succinic acid, lactic acid (L-form), salicylic acid, sulfamic acid, sodium gluconate, acetylacetone, pyrocatechol, tetrasodium iminodisuccinate (IDS), diethylenetriamine pentaacetic acid (DTPA), ethylenediamine tetraacetic acid (EDTA), glycine, calcium lactate (L-form), malic acid (DL-form), fructose (D-form), glucose (D-form), lactose, sucrose, calcium chloride, calcium nitrite, calcium nitrate, calcium sulfate (anhydrous form), sodium thiosulfate, potassium sulfide, and aluminum sulfate (as hydrate with 18H₂O) were purchased from Sigma-Aldrich in high purity and used as received.

BOF slag used was a steelmaking slag with a Blaine surface of 3000 cm²/g. The BOF slag had the following approximate chemical composition:

| CaO | Fe₂O₃ | SiO₂ | MgO | Al₂O₃ | MnO | P₂O₅ | TiO₂ | SO₃ | Others |
|---|---|---|---|---|---|---|---|---|---|
| 49.7% | 23.5% | 13.5% | 4.6% | 3.6% | 2.1% | 1.7% | 0.9% | 0.2% | 0.2% |

GGBS used was a ground granulated blast furnace slag with a Blaine surface of 4500 cm²/g. The GGBS slag had the following approximate chemical composition:

| CaO | Fe₂O₃ | SiO₂ | MgO | Al₂O₃ | MnO | TiO₂ | Others |
|---|---|---|---|---|---|---|---|
| 42.4% | 0.7% | 36.5% | 8.1% | 10.4% | 0.4% | 0.5% | 1.0% |

Calcium sulfoaluminate cement (CSA) and calcium aluminate cement (CAC) used had a particle size <100 microns and had the following chemical composition:

| | CaO | Al₂O₃ | Fe₂O₃ | SiO₂ | TiO₂ | MgO | K₂O | SO₃ |
|---|---|---|---|---|---|---|---|---|
| CSA | 44.0% | 23.0% | 11.0% | 10.0% | 1.5% | 0.7% | 0.3% | 7.7% |
| CAC | 36.0% | 40.0% | 16.0% | 4.0% | | | | |

Metakaolin used was a flash calcined metakaolin with a particle size <100 microns and with the following chemical composition, crude clay #1 and crude clay #2 were crude kaolinitc clays with a particle size <100 microns and with the following chemical composition. All materials had a weight loss at 100° C.<0.1%.

| | SiO₂ | Al₂O₃ | Fe₂O₃ | TiO₂ | CaO | K₂O | SO₃ |
|---|---|---|---|---|---|---|---|
| Metakaolin | 56.0% | 39.0% | 0.8% | 1.2% | 0.7% | 0.4% | 0.7% |
| crude clay #1 | 52.4% | 25.6% | 9.7% | 1.4% | 0.2% | 1.0% | |
| crude clay #2 | 23.5% | 23.6% | 37.9% | 1.8% | 0.3% | | |

Water used was demineralized water.

Compressive strength was measured according to EN 12190 on 4×4×16 cm prisms after the time indicated in the below tables. Curing was effected for 24 hours in moulds covered with plastic sheet to avoid desiccation. Demoulding was done after 24 hours and further curing was effected in sealed plastic bags to avoid desiccation.

Abbreviations used in the below tables 1-4 are the same as described above.

### Examples 1-51

Examples 1-51 show the effectiveness of various accelerators for the reaction of BOF slag with water. Example 1 is a comparative example and not according to the invention. Examples 2-51 are examples according to the invention.

Dry BOF slag was mixed with water in the amounts indicated in the below table 1. The respective accelerators were pre-mixed in the mixing water and thus added together with the mixing water in the amount indicated in below table 1. Mixing was effected for 3 mi on a Hobart mixer. The dosages of BOF slag and water indicated in below table 1 for examples 1-51 refer to weight in grams. The dosages indicated for the accelerators in below table 1 refer to a molar concentration of the respective accelerator in the mixing water in mol/liter.

TABLE 1
examples 1-51

| | 1 | 2 | 3 | 4 | 5 | 6 | 7 | 8 | 9 | 10 |
|---|---|---|---|---|---|---|---|---|---|---|
| BOF slag | 100 | 100 | 100 | 100 | 100 | 100 | 100 | 100 | 100 | 100 |
| Water | 29 | 29 | 29 | 29 | 29 | 29 | 29 | 29 | 29 | 29 |
| TIPA | | 0.1 | 0.01 | | | | | | | |
| DEIPA | | | | 0.1 | 0.01 | | | | | |
| EDIPA | | | | | | 0.1 | | | | |
| Citric acid | | | | | | | 0.1 | | | |
| Tartaric acid | | | | | | | | 0.1 | | |
| Malonic acid | | | | | | | | | 0.1 | |
| Succinic acid | | | | | | | | | | 0.1 |
| Lactic acid | | | | | | | | | | |
| Compressive | 1.1 | 5.4 | 2.5 | 1.7 | 4.2 | 5.4 | 1.5 | 1.4 | 2.7 | 1.4 |
| strength | | | | | | | | | | |
| @ 7 d [MPa] | | | | | | | | | | |
| | 11 | 12 | 13 | 14 | 15 | 16 | 17 | 18 | 19 | 20 |
| BOF slag | 100 | 100 | 100 | 100 | 100 | 100 | 100 | 100 | 100 | 100 |
| Water | 20 | 29 | 29 | 29 | 29 | 29 | 29 | 29 | 29 | 29 |
| Lactic acid | 0.1 | | | | | | | | | |
| Sulfamic acid | | 0.1 | | | | | | | | |
| Sodium gluconate | | | 0.1 | | | | | | | |
| Acetylacetone | | | | 0.1 | | | | | | |
| Pyrocatechol | | | | | 0.1 | | | | | |
| IDS | | | | | | 0.1 | | | | |
| DTPA | | | | | | | 0.1 | | | |
| Glycine | | | | | | | | 0.1 | | |
| Calcium lactate | | | | | | | | | 0.1 | |
| Malic acid | | | | | | | | | | 0.1 |
| Compressive strength | 1.9 | 1.5 | 1.5 | 2.9 | 2.5 | 2 | 1.5 | 2 | 2.3 | 1.6 |
| @ 7 d [MPa] | | | | | | | | | | |
| | 21 | 22 | 23 | 24 | 25 | 26 | 27 | 28 | | |
| BOF slag | 100 | 100 | 100 | 100 | 100 | 100 | 100 | 100 | | |
| Water | 29 | 19.5 | 29 | 29 | 29 | 29 | 29 | 29 | | |
| TIPA | 0.1 | 0.1 | 0.1 | 0.01 | 0.01 | | | | | |
| DEIPA | | | | | | 0.1 | 0.01 | 0.01 | | |
| Fructose | 0.1 | 0.1 | 0.01 | 0.1 | 0.01 | 0.1 | 0.1 | 0.01 | | |
| Compressive strength | 8 | 28 | 5.5 | 7.0 | 5.4 | 3.9 | 5.4 | 4.4 | | |
| @ 7 d [MPa] | | | | | | | | | | |
| | 29 | 30 | 31 | 32 | 33 | 34 | 35 | 36 | 37 | |
| BOF slag | 100 | 100 | 100 | 100 | 100 | 100 | 100 | 100 | 100 | |
| Water | 29 | 29 | 29 | 29 | 29 | 29 | 29 | 29 | 29 | |
| TIPA | 0.1 | 0.1 | 0.1 | 0.1 | 0.1 | 0.01 | 0.01 | | | |
| DEIPA | | | | | | | | 0.1 | | |
| Glucose | 0.1 | | | | | | | | | |
| Sucrose | | 0.05 | | | | | | | | |
| Lactose | | | 0.05 | | | | | | | |
| Citric acid | | | | 0.1 | 0.01 | 0.1 | 0.01 | 0.1 | | |
| Tartaric acid | | | | | | | | | 0.1 | |
| Compressive strength | 6.8 | 4.9 | 6.1 | 8.6 | 4.7 | 6.4 | 3.0 | 8.6 | 5.9 | |
| @ 7 d [MPa] | | | | | | | | | | |
| | 38 | 39 | 40 | 41 | 42 | 42 | 44 | | | |
| BOF slag | 100 | 100 | 100 | 100 | 100 | 100 | 100 | | | |
| Water | 29 | 29 | 29 | 29 | 29 | 29 | 29 | | | |
| TIPA | 0.1 | 0.1 | 0.01 | 0.01 | | | | | | |
| DEIPA | | | | | 0.1 | 0.01 | 0.01 | | | |
| Tri potassium citrate | 0.1 | 0.01 | 0.1 | 0.01 | 0.1 | 0.1 | 0.01 | | | |
| Compressive strength | 9.5 | 4.6 | 10.4 | 4.1 | 2.3 | 12.4 | 3.9 | | | |
| @ 7 d [MPa] | | | | | | | | | | |
| | 45 | 46 | 47 | 48 | 49 | 50 | 51 | | | |
| BOF slag | 100 | 100 | 100 | 100 | 100 | 100 | 100 | | | |
| Water | 29 | 29 | 29 | 29 | 29 | 29 | 29 | | | |
| TIPA | 0.1 | 0.1 | 0.1 | 0.1 | 0.1 | 0.1 | 0.1 | | | |
| Malonic acid | 0.1 | | | | | | | | | |
| Succinic acid | | 0.1 | | | | | | | | |
| Lactic acid | | | 0.1 | | | | | | | |
| Glycine | | | | 0.1 | | | | | | |
| IDS | | | | | 0.1 | | | | | |
| Sulfamic acid | | | | | | 0.1 | | | | |
| Pyrocatechol | | | | | | | 0.1 | | | |
| Compressive strength | 4.8 | 5.4 | 4.8 | 6.4 | 5.6 | 4.9 | 3.3 | | | |
| @ 7 d [MPa] | | | | | | | | | | |

As can be from the above table 1, TIPA, DEIPA, EDIPA, citric acid, tartaric acid, malonic acid, succinic acid, lactic acid, sulfamic acid, sodium gluconate, acetylacetone, pyrocatechol, IDS, DTPA, glycine, calcium lactate, and malic acid are suitable accelerators for the reaction of BOF slag with water as the compressive strength after 7d is increased compared to the sample where BOF slag reacts only with water (example 1).

It can also be seen from the above table 1, that mixtures of TIPA with any of fructose, glucose, lactose, sucrose, citric acid, tri-potassium citrate, tartaric acid, malonic acid, succinic acid, lactic acid, sulfamic acid, glycine, pyrocatechol, IDS are especially well suited accelerators for the reaction of BOF slag with water. The same is true for mixtures of DEIPA with fructose, tripotassium citrate and citric acid.

From a comparison of examples 1, 21, and 22 it is also obvious that accelerators of the present invention can act to reduce the water demand of BOF slag. It is to be noted that the consistency of examples 1 and 22 were the same. A reduced amount of water needed to achieve the same consistency can be used to further increase the strength, as is evident from a comparison of examples 1, 21, and 22.

### Examples 52-66

Examples 52-66 show the effectiveness of various mineral salts as accelerators for the reaction of BOF slag with water. Example 52 is a comparative example and not according to the invention. Examples 53-66 are examples according to the invention.

Dry BOF slag was dry mixed with the respective mineral salt in the amounts indicated in the below table 2 until visually homogeneous. Where TIPA and fructose were additionally added, they were pre-mixed in the mixing water and thus added together with the mixing water in the amount indicated in below table 2. Mixing of dry mix and mixing water was effected for 3 min on a Hobart mixer. The respective dosages of BOF slag, water, and mineral salt indicated in below table 2 for examples 52-66 refer to weight in grams. The dosages indicated for TIPA and fructose in below table 2 refer to a molar concentration of the respective accelerator in the mixing water in mol/liter.

TABLE 2
examples 52-66

| | | 52 | 53 | 54 | 55 | 56 | 57 | 58 | |
|---|---|---|---|---|---|---|---|---|---|
| BOF slag | | | 96.8 | 96.8 | 96.8 | 96.2 | 96.2 | 96.2 | |
| Water | | 29 | 29 | 29 | 29 | 29 | 29 | 29 | |
| CaCl₂ | | | 3.2 | 3.2 | 3.2 | | | | |
| Ca(NO₂)₂ | | | | | | 3.8 | 3.8 | 3.8 | |
| TIPA | | | | 0.02 | 0.02 | | 0.02 | 0.02 | |
| Fructose | | | | | 0.1 | | | 0.1 | |
| Com- | @ 2 d | 0.5 | 2 | 7.8 | 12.4 | 0.8 | 1.2 | 8.7 | |
| pressive | @ 10 d | 1.6 | 11 | 11.9 | 19.4 | 5.5 | 9.4 | 14.8 | |
| strength | @ 28 d | 12.8 | 21.4 | 19.1 | 30.3 | 13.8 | 11.7 | 24.4 | |
| [MPa] | | | | | | | | | |
| | | 59 | 60 | 61 | 62 | 63 | 64 | 65 | |
| BOF slag | | 93 | 93 | 93 | 96.8 | 96.8 | 96.6 | 97 | 95.8 |
| Water | | 29 | 29 | 29 | 29 | 29 | 29 | 29 | 29 |
| Ca(NO₃)₂ | | 7 | 7 | 7 | | | | | |
| Al₂(SO₄)₃ | | | | | 3.2 | | | | |
| CaSO₄ | | | | | | 3.2 | 3.2 | | |
| Na₂S₂O₃ | | | | | | | | 3 | |
| Potassium sulfide | | | | | | | | | 4.2 |
| TIPA | | | 0.02 | 0.02 | 0.02 | | 0.02 | | |
| Fructose | | | | 0.1 | 0.1 | | | | |
| Com- | @ 2 d | 1.4 | 8.1 | 12.4 | 10.4 | 0.7 | 8.3 | 4.5 | 6.3 |
| pressive | @ 10 d | 4.7 | 10.6 | 16.8 | 19.1 | 6 | 13 | 13.9 | 14.8 |
| strength | @ 28 d | 13.9 | 14.6 | 25.0 | 23.6 | 15.9 | n.m. | 21.7 | 19.2 |
| [MPa] | | | | | | | | | |

n.m.: not measured

As can be from the above table 2, calcium chloride, calcium nitrite, calcium nitrate, calcium sulfate, sodium thiosulfate, and potassium sulfide are suitable accelerators for the reaction of BOF slag with water as the compressive strength after 7d is increased compared to the sample where BOF slag reacts only with water (example 52).

As can also be seen from table 2, the use of mixtures of TIPA and optionally additionally fructose with any of calcium chloride, calcium nitrite, calcium nitrate, calcium sulfate, and aluminum sulfate leads to particularly good acceleration of the reaction of BOF slag with water.

### Examples 67-75

Examples 67-75 show the effectiveness of various accelerators for the reaction of GGBS slag with water. Example 67 is a comparative example and not according to the invention. Examples 68-76 are examples according to the invention.

Dry GGBS slag was dry mixed with the hydrated lime in the amounts indicated in the below table 3 until visually homogeneous. Hydrated lime was added as an activator for the GGBS. The respective accelerators were pre-mixed with the mixing water and thus added together with the mixing water in the amounts indicated in below table 3. Mixing was effected for 3 min on a Hobart mixer. The dosages of GGBS slag, hydrated lime, and water indicated in below table 3 for examples 67-75 refer to weight in grams. The dosage indicated for the accelerators in below table 3 refers to a molar concentration of the respective accelerator in the mixing water in mol/liter.

TABLE 3
Examples 67-75

| | 67 | 68 | 69 | 70 | 71 | 72 | 73 | 74 | 75 |
|---|---|---|---|---|---|---|---|---|---|
| GGBS slag | 90 | 90 | 90 | 90 | 90 | 90 | 90 | 90 | 90 |
| Lime | 10 | 10 | 10 | 10 | 10 | 10 | 10 | 10 | 10 |
| Water | 36 | 36 | 36 | 36 | 36 | 36 | 36 | 36 | 36 |
| TIPA | | 0.01 | | | | | | | |
| Malonic acid | | | 0.1 | | | | | | |
| Succinic acid | | | | 0.1 | 0.01 | | | | |
| Salicylic acid | | | | | | 0.01 | | | |
| Pyrocatechol | | | | | | | 0.01 | | |
| IDS | | | | | | | | 0.01 | |
| EDTA | | | | | | | | | 0.01 |
| Compressive | 16 | 18.5 | 21.8 | 19.4 | 17.8 | 17.7 | 20.8 | 18 | 18 |
| strength | | | | | | | | | |
| @ 7 d [MPa] | | | | | | | | | |

As can be from the above table 3, TIPA, malonic acid, succinic acid, salicylic acid, pyrocatechol, IDS, and EDTA are suitable accelerators for the reaction of the mixture of GGBS and hydrated lime with water.

### Examples 76 to 83

Examples 76-83 show the effectiveness of various accelerators for the reaction of mixtures of GGBS slag and BOF slag with water. Example 76 is a comparative example and not according to the invention. Examples 77-83 are examples according to the invention.

Dry BOF slag, dry GGBS slag, and the respective mineral salts were dry mixed in the amounts indicated in the below table 4 until visually homogeneous. Where TIPA, fructose, citric acid, and/or citrates were additionally added, they were pre-mixed in the mixing water and thus added together with the mixing water in the amount indicated in below table 4. Mixing of dry mix and mixing water was effected for 3 min on a Hobart mixer. The respective dosages of slag, water, and mineral salt indicated in below table 4 refer to weight in grams. The dosages indicated for TIPA, fructose, citric acid, and/or citrates in below table 4 refer to a molar concentration of the respective accelerator in the mixing water in mol/liter.

TABLE 4
Examples 76-83

| | 76 | 77 | 78 | 79 | 80 | 81 | 82 | 83 |
|---|---|---|---|---|---|---|---|---|
| Silica sand | 70 | 67.7 | 67.7 | 65.5 | 65.5 | 65.5 | 65.5 | 65.5 |
| 0-800 μm | | | | | | | | |
| BOF slag | 19.5 | 18.9 | 18.9 | 18.3 | 18.3 | 18.3 | 18.3 | 18.3 |
| GGBS slag | 10.5 | 10.2 | 10.2 | 9.8 | 9.8 | 9.8 | 9.8 | 9.8 |
| CaCl₂ | | 3.2 | | 3.2 | 3.2 | 3.2 | 3.2 | 3.2 |
| CaSO₄ | | | 3.2 | 3.2 | 3.2 | 3.2 | 3.2 | 3.2 |
| Water | 29 | 29 | 29 | 29 | 29 | 29 | 29 | 29 |
| TIPA | | | | | 0.01 | 0.01 | 0.01 | 0.01 |
| Fructose | | | | | 0.01 | | | |
| Citric acid | | | | | | 0.01 | | |
| Tri sodium | | | | | | | 0.01 | |
| citrate | | | | | | | | |
| Tri potassium | | | | | | | | 0.01 |
| citrate | | | | | | | | |
| Compressive | 0.6 | 8.8 | 5.6 | 10.4 | 17.6 | 13.6 | 13.1 | 13.3 |
| strength | | | | | | | | |
| @ 7 d [MPa] | | | | | | | | |

As can be from the above table 4, calcium chloride, calcium sulfate, TIPA, citric acid, and citric acid salts are suitable accelerators for the reaction of the mixture of GGBS and BOF slag with water.

### Examples 84-93

Examples 84-93 show the effectiveness of a mixture of TIPA and trisodium citrate for the reaction of BOF slag alone or BOF slag in combination with co-binders with water. Examples 84-93 are examples according to the present invention.

Dry BOF slag and optionally co-binders were dry mixed in the amounts indicated in the below table 5 until visually homogeneous. TIPA and trisodium citrate were pre-mixed in the mixing water and thus added together with the mixing water in the amount indicated in below table 5. Mixing of dry mix and mixing water was effected for 3 min on a Hobart mixer. The respective dosages of slag, co-binder, mineral salt, and water in below table 5 refer to weight in grams. The dosages indicated for TIPA and trisodium citrate refer to a molar concentration of the respective accelerator in the mixing water in mol/liter.

TABLE 5
Examples 84-93

| | 84 | 85 | 86 | 87 | 88 | 89 | 90 | 91 | 92 | 93 |
|---|---|---|---|---|---|---|---|---|---|---|
| BOF slag | 100 | 90 | 80 | 79.2 | 76 | 79.4 | 74.8 | 73.4 | 74.6 | 80.2 |
| Metakaolin | | 10 | 10 | 9.9 | 9.5 | 9.9 | | | | |
| crude clay #1 | | | | | | | 15.2 | | | |
| crude clay #2 | | | | | | | | 16.6 | | |
| CaSO₄ | | | 10 | 9.9 | 9.5 | 9.9 | 10 | 10 | 8.5 | 10 |
| CSA | | | | 1 | 5 | | | | 17 | |
| CAC | | | | | | | | | | 9.8 |
| Water | 29 | 29 | 29 | 29 | 29 | 29 | 29 | 29 | 29 | 29 |
| TIPA | 0.1 | 0.1 | 0.1 | 0.1 | 0.1 | 0.1 | 0.1 | 0.1 | 0.1 | 0.1 |
| Tri sodium citrate | 0.1 | 0.1 | 0.1 | 0.1 | 0.1 | 0.1 | 0.1 | 0.1 | 0.1 | 0.1 |
| Al₂(SO₄)₃ | | | | | | 0.8 | | | | |
| Compressive | n.m. | n.m. | 13.0 | 22.1 | 31.7 | 24.1 | n.m. | n.m. | n.m. | n.m. |
| strength | | | | | | | | | | |
| @ 2 d [MPa] | | | | | | | | | | |
| Compressive | 16.6 | 26.3 | 40.2 | n.m. | n.m. | 41.3 | 23.9 | 29.7 | 39.2 | 34.7 |
| strength | | | | | | | | | | |
| @ 7 d [MPa] | | | | | | | | | | |

n.m.: not measured

Surprisingly, it was found that the combination of alkanolamine with a trisodium salt of citric acid gives particular good performance (cf example 84 with example 38).

The results of table 5 also show that various co-binders can be used together with the slag based binder. Also, from the above examples, it becomes obvious that aluminum sulfate is a suitable accelerator.

### Examples 94-98

Examples 94-98 show the show the usefulness of a slag based binder of the present invention in mortar formulations. Example 94 is not according to the present invention, examples 95-98 are according to the present invention.

Dry OPC or BOF slag, aggregates and fillers, optionally co-binders, and additives were dry mixed in the amounts indicated in the below table 6 until visually homogeneous. DEIPA and trisodium citrate were pre-mixed in the mixing water and thus added together with the mixing water in the amount indicated in below table 6. Mixing of dry mix and mixing water was effected for 3 min on a Hobart mixer. The respective dosages of OPC or BOF slag, aggregates and fillers, co-binders, additives, and water in below table 6 refer to weight in grams. The dosages indicated for DEIPA and trisodium citrate refer to a molar concentration of the respective accelerator in the mixing water in mol/liter.

TABLE 6
Examples 94-98

| | 94 | 95 | 96 | 97 | 98 |
|---|---|---|---|---|---|
| Portland cement (CEM I 42.5 R) | 36.8 | 7.4 | | | |
| BOF slag | | 29.4 | 36.8 | 16 | 20 |
| Metakaolin | | 3.7 | 3.7 | 2 | 2.5 |
| CaSO₄ | | 3.7 | 4.6 | 1.6 | 2.5 |
| Quartz sand*¹ | 54.1*¹ | 46.3*¹ | 45.4*¹ | 70*² | 64.71*² |
| CaCO₃ filler*³ | 6.7 | 6.7 | 6.7 | 10 | 10 |
| Additives*⁴ | 2.4 | 2.4 | 2.4 | | |
| Water | 15.6 | 15.6 | 15.6 | | |
| AlCl₃ | | | | 0.18 | |
| Al₂(SO₄)₃ | | | | | 0.2 |
| DEIPA | | 0.13 | 0.17 | 0.064 | 0.03 |
| Tri sodium citrate | | 0.25 | 0.3 | 0.12 | 0.054 |
| Compressive strength @ 1 d [MPa] | 20.6 | 19.2 | 23.4 | 5.6 | 10.4 |
| Compressive strength @ 28 d [MPa] | 45.1 | 43.5 | 36.9 | 11.2 | 18.7 |

*¹1:1 mixture of 0.2-2 mm and 2-4 mm quartz sand
*²0.2-2 mm quartz sand
*³ground limestone < 200 micron particle size
*⁴additives: thickener (cellulose ether), redispersible polymer powder, PP fibers, defoamer, anti-shrinkage agent

Example 94 is a formulation of typical repair mortars and included for comparative purposes. Targeted performance of such repair mortars is a minimum compressive strength of 10 MPa within 1 d and of 30 MPa within 28 days of curing. As can be seen by the inventive examples 95 and 96, such requirements can be met by a mortar composition according to the present invention with or without Portland cement as a co-binder. Examples 97 and 98 are formulations useful as masonry mortars. Typically, for masonry mortars, a compressive strength after 1 d of at least 4 MPa and after 28 days of at least 10 MPa is required. These requirements are met by inventive examples 97 and 98.

1. The use of an accelerator for the reaction of steelmaking slag with water, the accelerator being selected from the group consisting of alkanolamines, reducing agents, sugars, sugar acids, carboxylic acids and their salts, amino acids and their salts, sulfamic acid, glyoxal, acetylacetone, pyrocatechol, nitrilotri(methylphosphonic acid), etidronic acid, mineral salts, or mixtures thereof.

2. The use according to claim 1, wherein the steelmaking slag is a basic oxygen furnace slag.

3. The use according to claim 1, wherein the steelmaking slag has a content of iron oxides expressed as Fe₂O₃ of 8-38 w % in each case relative to the total dry weight of the steelmaking slag.

4. The use according to claim 1, wherein the accelerator is selected from the group consisting of triethanolamine (TEA), triisopropanolamine (TIPA), diethanolisopropanolamine (DEIPA), ethanoldiisopropanolamine (EDIPA), fructose, mannose, maltose, glucose, galactose, dextrines, vinasse, molasses, gluconic acid, ascorbic acid, neuraminic acid, glucuronic acid, galacturonic acid, iduronic acid, mucilic acid, saccharic acid and their sodium, potassium or calcium salts, formic acid, glycolic acid, citric acid, lactic acid, malic acid, tartaric acid, oxalic acid, malonic acid, succinic acid, glutaric acid, adipic acid, salicylic acid and their sodium, potassium or calcium salts, glycine, glutamic acid, aspartic acid, polyaspartic acid, tetrasodium iminodisuccinate (IDS), diethylenetriamine-pentaacetic acid (DTMA), nitrilotriacetic acid (NTA), sulfamic acid, glyoxal, acetylacetone, pyrocatechol, nitrilotri(methylphosphonic acid), etidronic acid, calcium nitrite, calcium nitrate, calcium chloride, magnesium chloride, calcium sulfate, aluminum sulfate, aluminum chloride, thiosulfates, thiocyanates, and sulfides.

5. The use according to claim 1, wherein the accelerator is a mixture of two alkanolamines or of an alkanolamine with at least one further accelerator different from an alkanolamine.

6. The use according to claim 5, wherein the alkanolamine is selected from the group consisting of triethanolamine (TEA), triisopropanolamine (TIPA), diethanolisopropanolamine (DEIPA), ethanoldiisopropanolamine (EDIPA), and methyldiethanolamine (MDEA), and in that the at least one further accelerator is one further accelerator which is selected from the group consisting of fructose, mannose, maltose, glucose, galactose, dextrines, vinasse, molasses, gluconic acid, ascorbic acid, neuraminic acid, glucuronic acid, galacturonic acid, iduronic acid, mucilic acid, saccharic acid and their sodium, potassium or calcium salts, formic acid, glycolic acid, citric acid, lactic acid, malic acid, tartaric acid, oxalic acid, malonic acid, succinic acid, glutaric acid, adipic acid, salicylic acid and their sodium, potassium or calcium salts, glycine, glutamic acid, aspartic acid, polyaspartic acid, tetrasodium iminodisuccinate (IDS), diethylenetriaminepentaacetic acid (DTMA), nitrilotriacetic acid (NTA), sulfamic acid, glyoxal, acetylacetone, pyrocatechol, nitrilotri(methylphosphonic acid), etidronic acid, calcium nitrite, calcium nitrate, calcium chloride, magnesium chloride, calcium sulfate, aluminum sulfate, aluminum chloride, thiosulfates, thiocyanates, and sulfides.

7. The use according to claim 5, wherein the alkanolamine is selected from the group consisting of triethanolamine (TEA), triisopropanolamine (TIPA), diethanolisopropanolamine (DEIPA), ethanoldiisopropanolamine (EDIPA), and methyldiethanolamine (MDEA), and in that two further accelerators are present, the first further accelerator being selected from sugars, and the second further accelerator being selected from the group consisting of mineral salts and reducing agents.

8. The use according to claim 5, wherein the alkanolamine is selected from the group consisting of triethanolamine (TEA), triisopropanolamine (TIPA), diethanolisopropanolamine (DEIPA), ethanoldiisopropanolamine (EDIPA), and methyldiethanolamine (MDEA), and in that two further accelerators are present, the first further accelerator being selected from sugars, and the second further accelerator being selected from the group consisting of sugar acids, carboxylic acids and sulfamic acid, and their sodium, potassium or calcium salts, formic acid, glycolic acid, citric acid, lactic acid, malic acid, tartaric acid, oxalic acid, malonic acid, succinic acid, glutaric acid, adipic acid, and their sodium, potassium or calcium salts.

9. The use according to claim 5, wherein the alkanolamine is selected from the group consisting of triethanolamine (TEA), triisopropanolamine (TIPA), diethanolisopropanolamine (DEIPA), ethanoldiisopropanolamine (EDIPA), and methyldiethanolamine (MDEA), and in that three further accelerators are present, the first further accelerator being selected from sugars, and the second further accelerator being selected from the group consisting of sugar acid, carboxylic acids and sulfamic acid, and their sodium, potassium or calcium salts, formic acid, glycolic acid, citric acid, lactic acid, malic acid, tartaric acid, oxalic acid, malonic acid, succinic acid, glutaric acid, adipic acid, salicylic acid and their sodium, potassium or calcium salts, and the third further accelerator being selected from the group consisting of mineral salts and reducing agents.

10. The use according to claim 1, wherein the accelerator is added in a total amount of between 0.005-25 w %, relative to the total dry weight of the slag.

11. A slag based binder comprising or consisting of
a) at least one steelmaking slag,
b) at least one accelerator for the reaction of the steelmaking slag with water, the accelerator being selected from the group consisting of alkanolamines, reducing agents, sugars, sugar acids, carboxylic acids or their salts, amino acids or their salts, sulfamic acid, glyoxal, acetylacetone, pyrocatechol, nitrilotri(methylphosphonic acid), etidronic acid, mineral salts, or mixtures thereof,
c) optionally a second slag which is different from a),
d) optionally at least one co-binder,
e) optionally further additives different from b).

12. A slag based binder comprising or consisting of
a) at least one steelmaking slag,
b) at least one accelerator for the reaction of the steelmaking slag with water, the accelerator being selected from the group consisting of alkanolamines, reducing agents, sugars, sugar acids, carboxylic acids or their salts, amino acids or their salts, sulfamic acid, glyoxal, acetylacetone, pyrocatechol, nitrilotri(methylphosphonic acid), etidronic acid, mineral salts, or mixtures thereof,
c) optionally a second slag which is different from a),
d) optionally at least one co-binder,
e) optionally further additives different from b) wherein the accelerator is selected from the accelerators of claim 4.

13. A construction material comprising or consisting of (in each case relative to the total dry weight of the construction material)
a) 5-95 w %, the slag based binder comprising or consisting of
a1) at least one steelmaking slag,
a2) at least one accelerator for the reaction of the steelmaking slag with water, the accelerator being selected from the group consisting of alkanolamines, reducing agents, sugars, sugar acids, carboxylic acids or their salts, amino acids or their salts, sulfamic acid, glyoxal, acetylacetone, pyrocatechol, nitrilotri(methylphosphonic acid), etidronic acid, mineral salts, or mixtures thereof,
a3) optionally a second slag which is different from a1),
b) 5-95 w % of at least one aggregate,
c) 9-90 w % of at least one co-binder, the co-binder being different from the slag based binder a) and the co-binder being selected from the group consisting of cement, gypsum, lime, calcined magnesia, caustic magnesia, alumina, latent hydraulic binders, and/or pozzolanes,
d) 0-10 w % of further additives, and
e) optionally water in an amount to realize a mass ratio of water:dry constituents between 0.1-0.6.

14. A construction material according to claim 13, wherein the construction material comprises at least one co-binder in 5-90 w %, the co-binder being selected from Portland cement, calcium aluminate cement, calcium sulfoaluminate cement, gypsum, hydraulic lime, air lime, calcined magnesia, caustic magnesia, calcined alumina, hydratable alumina, aluminum hydroxide, pozzolanes, and latent hydraulic binder,
where pozzolane and latent hydraulic binder does not encompass slag.

15. A slag based binder comprising or consisting of
a) at least one steelmaking slag,
b) at least one accelerator for the reaction of the steelmaking slag with water, the accelerator being selected from the group consisting of alkanolamines, reducing agents, sugars, sugar acids, carboxylic acids or their salts, amino acids or their salts, sulfamic acid, glyoxal, acetylacetone, pyrocatechol, nitrilotri(methylphosphonic acid), etidronic acid, mineral salts, or mixtures thereof,
c) optionally a second slag which is different from a),
d) optionally at least one co-binder,
e) optionally further additives different from b) or a construction material according to claim 13, wherein a co-binder is present and a weight ratio of steelmaking slag to co-binder is between
1:19-19:1.

16. A hardened body obtained by curing a slag based binder as claimed in claim 11 and which slag based binder or construction material has been mixed with water in an amount to realize a mass ratio of water:dry powder between 0.1-0.6.
